(19) United States
(12) Patent Application Publication
(10) Pub. No.: US 2008/0283101 A1
(43) Pub. Date: Nov. 20, 2008

(54) DOUBLE DELIVERY PUMP FOR AN ELECTRIC HOUSEHOLD APPLIANCE AND ELECTRIC HOUSEHOLD APPLIANCE EQUIPPED THEREWITH

(75) Inventor: Gianluca Pardini, Lucca (IT)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 12/122,255

(22) Filed: May 16, 2008

(30) Foreign Application Priority Data
May 16, 2007 (IT) TO2007A000347

(51) Int. Cl. B08B 3/02; F04D 1/00

(52) U.S. Cl. 134/174; 415/206; 29/428

(57) ABSTRACT

A double delivery pump for an electric appliance includes a pump body housing a centrifugal impeller and provided with a first delivery pipe and with a second delivery pipe having passage sections which are different from one another and located at diametrically opposite positions with respect to a rotation axis of the impeller. First and second fastening portions are provided for selective mounting of the pump to a casing of the electric appliance, either with the first delivery pipe arranged above and with the second delivery pipe arranged below the axis of rotation of the impeller or vice versa, so that the pump depending on which fastening means are selected, may be used either on a professional dishwasher or glasswasher. The pump body includes a cup-shaped scroll, a closing lid of a mouthpiece of the scroll, which may be housed in a seat defined by an annular collar of the scroll and axially carrying a suction pipe, the lid arranged in use in axial abutment against a bottom wall of the annular collar with the interposition of a sealing ring, and a threaded locking ring, coupled with a threaded segment of the collar to axially press in use the lid against the bottom wall, uniformly along a peripheral edge of the lid.

### TECHNICAL FIELD

The present application relates to a double delivery centrifugal pump for an electric appliance, specifically a dishwasher and/or a glasswasher of the professional/commercial use type.

### BACKGROUND

It is known that dishwashers, in particular those for professional use (for bars, restaurants, communities, etc.) include a washing chamber provided with upper and lower washing means (e.g., usually upper and lower washing arms) and delimited downwards by a collection sump of the service fluid (washing water), also referred to as cleaning liquid, which is, at least partially, filtered and recycled by a feeding pump, which draws the service fluid from the sump and sends it to the washing arms.

Therefore, the flow of service fluid fed by the pump needs to be split into two separate flows, to be indeed separately fed to both the upper and lower washing arms. Furthermore, in dishwashers of different types, the flow rate of service fluid to be fed to the upper and lower washing arms may be different; in particular, dishwashers for professional use may be specialised machines, e.g. machines for washing plates in which the greater flow of water is to be directed to the upper washing arm, and glasswashers in which the greater flow of water is to be directed to the lower washing arm (e.g., due to the fact that glasses are almost always placed in the washing cavity in an inverted manner). As used herein the term “warewasher” collectively refers to both dishwasher and glasswashers.

In order to split and adjust the flow of water, possibly with the addition of detergents (service fluid), deviating means are used in the form of valves or simply in T-fittings provided with calibrated bottleneck, which intercept the flow downstream of the pump delivery pipe in relation to the flow rates to be obtained. From EP1004266, a feeding pump of a service fluid to the upper and lower washing arms of a dishwasher is however known, which displays two delivery pipes obtained on the same pump body, in diametrically opposite position. The need for deviating means is thus avoided because the same impeller of the pump simultaneously provides the two separated flows.

The pump known from EP1004266 however does not solve the problem of being able to direct different flow rates to the upper and lower washing arms of the dishwasher.

### SUMMARY

It would be desirable to overcome in a simple way the drawbacks of the known art by providing a feeding pump of a service fluid to the washing arms of an electric household appliance, specifically a dishwasher, which does not require deviating means for feeding separate, different flows to the washing arms of the electric household appliance and, above all, can be used without any changes both in electric household appliances which require the feeding of the greater flow rate of service fluid to the upper arm, such as dishwashers, and in electric household appliances which require the feeding of the greater flow rate of service fluid to the lower arm, such as glasswashers.

It would also be desirable to provide a pump of the aforesaid type which is at the same time reliable, compact, relatively cost-effective, simple and easy to be assembled and disassembled, and above all ensures a good sealing to the service fluid and finally facilitates maintenance interventions.

In one aspect, a pump includes a pump body fluid-sealingly housing a centrifugal impeller and provided with a first delivery pipe and a second delivery pipe located on the pump body in diametrically opposite, tangential positions with respect to a rotation axis of the impeller, and with first fastening means to a casing of the electric household appliance; the first and second delivery pipes, however, display passage sections which are different from one another and the pump also comprises, in combination with this feature, second fastening means to the casing of the electric household appliance.

The first and second fastening means may be specifically designed to be selectively used to assemble the pump body, either with the first delivery pipe arranged above and the second delivery pipe arranged below the rotation axis of the impeller or vice versa, so that the pump, depending on whether the first or the second fastening means are selected, may be used for an electric household appliance consisting either of a dishwasher or a glasswasher.

The pump body includes a hydraulic conveying scroll defined by a cup-shaped half-shell, a closing lid of a mouthpiece of the scroll, which may be housed in a seat defined by an annular collar of the scroll and axially carrying a suction pipe, the lid resting in use in axial abutment against an annular bottom wall of the annular collar, with the interposition of a sealing ring, and a threaded locking ring coupled with a threaded segment of the collar to axially and uniformly press in use the lid against the bottom wall along a peripheral edge of the lid itself.

In this manner, the same pump may be used, without any changes thereto, but by simply mounting it in an inverted position each time, on different and differently specialised dishwashers, for directing different flow rates of service fluid (water and possibly detergent) to different washing arms of the electric household appliance, with consequent great scale economies.

Furthermore, the pump may be easily and entirely formed by moulding a synthetic plastic material, with consequent reduction of costs and weight, without affecting the sealing reliability in use of the service fluid which is pumped; indeed, the specific composition and structure of the pump body allows to ensure an optimal and safe sealing between lid and scroll, by means of the screwed closing of the lid directly onto the scroll, obtained by means of the threaded locking ring/collar coupling, instead of using a flanged-type closure with several fastening screws, commonly used for dishwasher pumps.

Each first and second delivery pipe may be laterally provided perpendicularly to a side wall thereof, with a branched discharge conduit preferably obtained integrally in one piece with the pump body, externally on the same.

A first discharge conduit is closed in use by a plug and a second discharge conduit is instead connected in use to the sump of the electrical household appliance, from which the pump is intended to draw the service fluid in use.

In this manner, a complete emptying of the scroll is ensured when the pump is stopped and the sump is emptied, which greatly simplifies, along with the general structure of the pump body, the cleaning interventions, by improving the hygienic features of the dishwasher during the non-use periods, however without substantially penalising the step of pumping.

An electric household appliance, in particular a dishwasher or glasswasher for professional use, equipped with the aforesaid pump is provided.

### BRIEF DESCRIPTION OF THE DRAWINGS

Further aspects will be apparent from the following description of an embodiment thereof, provided only by way of non-limitative example and with reference to the accompanying drawings, in which:

FIG. 1 diagrammatically shows a front three quarters perspective view of a double delivery pump made according to the invention and of an electric household appliance, shown only diagrammatically and with a dashed line, equipped with such a pump according to the invention;

FIG. 2 shows an exploded perspective view of the pump in FIG. 1;

FIGS. 3a and 3b diagrammatically show the pump in FIGS. 1 and 2 in two different possible assembly configurations on an electric household appliance;

FIG. 4 shows a longitudinal section view of the pump in FIGS. 1 and 2 in an assembled configuration; and

FIG. 5 shows a perspective view of a detail of the pump in FIGS. 1 and 2.

### DETAILED DESCRIPTION

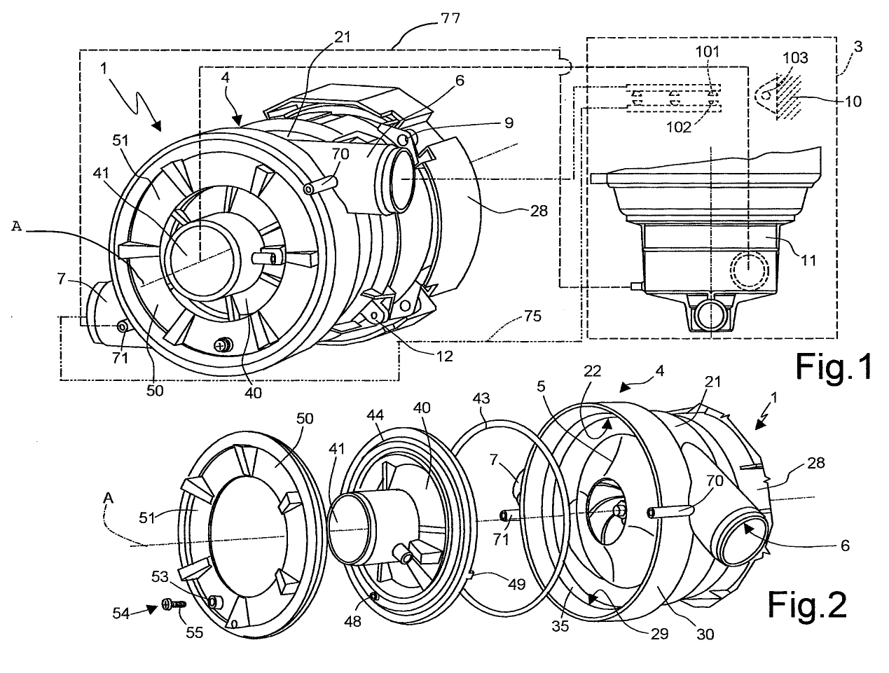

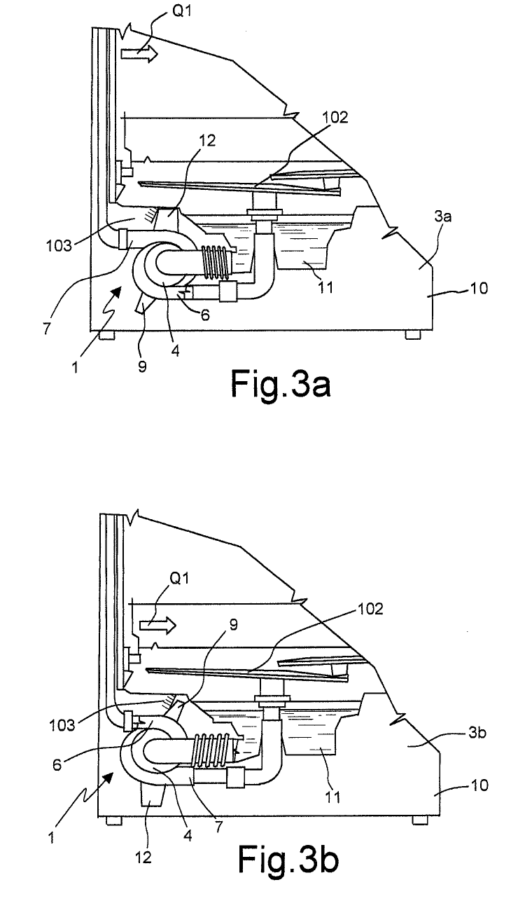

With reference to FIGS. 1 to 5, numeral 1 shows as a whole a double delivery pump for an electric household appliance 3, specifically a dishwasher, or more specifically in a professional machine 3a for washing plates (FIG. 3a), or in a professional machine 3b for washing glasses (FIG. 3b), shown For simplicity in FIG. 1 only with a dashed line in schematic block form.

The pump 1 includes a pump body 4 fluid-sealingly housing a centrifugal impeller 5 (of known type) and provided with a first delivery pipe 6 and a second delivery pipe 7 tangentially oriented on the pump body 4 in diametrically opposite positions with respect to a rotation axis A of the impeller 5. First fastening means 9 is provide for securing the pump to a casing 10 (e.g., housing or frame) of the electric appliance 3. The first delivery pipe 6 and the second delivery pipe 7 have passage sections (e.g., flow passages) which are different from one another. In particular the pipe 6 has a diameter smaller than the pipe 7 and, therefore, provides a smaller flow passage (i.e., a smaller cross-sectional flow area). Both the pipes tangentially draw from the inside of the pump body 4 and therefore receive the head generated by the impeller 5 in use to the same extent. However, the pipe 7 of larger section displays a lower load loss at the mouthpiece and is thus adapted to convey a higher flow rate Q1 (FIG. 3) of a service fluid pumped from a sump 11 of the appliance 3 as a consequence of the rotation of the impeller 5.

The pump 1 also includes second fastening means 12 that may be used for securing the pump to the casing 10 of the appliance 3. The first 9 and second 12 fastening means are designed to be selectively used, to mount the pump body 4, either with the first delivery pipe 6 arranged above and the second delivery pipe 7 arranged below the rotation axis A of the impeller (FIG. 3b) or vice versa (FIG. 3a), so that the pump 1, depending on whether the first 9 or the second 12 fastening means are selected, may be used for either of a glasswasher 3b or a dishwasher 3a, respectively.

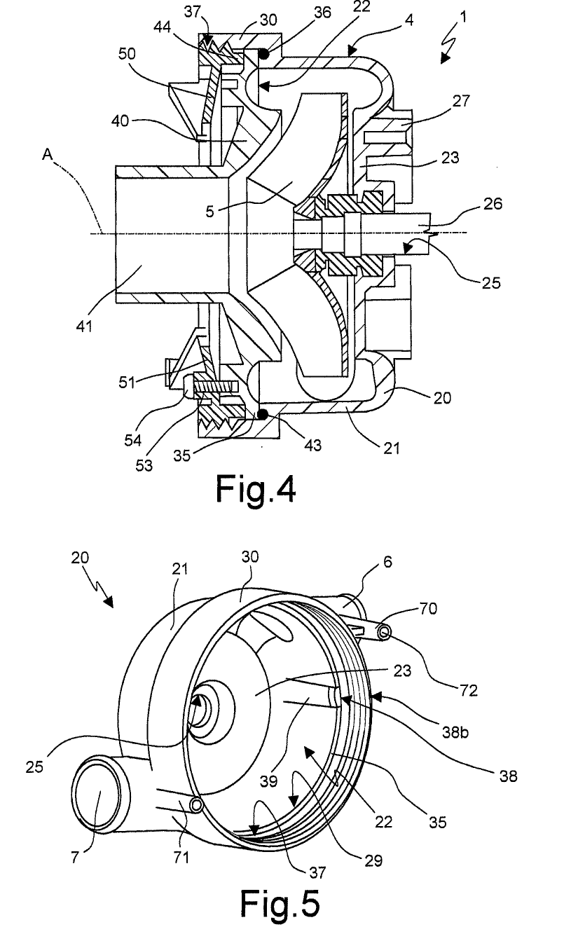

The pump body 4 includes a hydraulic conveying scroll 20 of the service fluid taken in by the impeller 5 and defined by a cup-shaped half-shell formed by moulding a synthetic plastic material in a single piece and comprising a side wall 21 and an end wall 23 (FIG. 5 and FIGS. 1, 2 and 4). The side wall 21 has a substantially cylindrical symmetry delimiting a mouthpiece 22 of the scroll 20, through which the impeller 5 is received in use into the scroll 20 in order to be idly housed therein and, in use, to convey through the scroll 20 itself and towards the delivery pipes 6,7 the service fluid. The bottom wall 23 (FIG. 4) is arranged opposite to and facing the mouthpiece 22. The delivery pipes 6, 7 are integrally obtained in one unitary piece with the side wall 21, tangentially and cantileverly protruding from the same, on opposite sides, transversely to the axis A.

In particular, the impeller 5 is axially and cantileverly supported within the scroll 20 by the bottom wall 23, through an axial passage hole 25 for a drive shaft 26. The bottom wall 23 is further provided, on the outside of the pump body 4, with fastening means 27 (e.g., a screw hole or other known structure) for mounting a driving motor 28.

Furthermore, the first 9 and second 12 fastening means, which may be selectively used, are carried outside the pump body 4, e.g. are carried by the side wall 21, are integrally obtained in one unitary piece with the same and formed by corresponding ears which radially and cantileverly protrude from the pump body 4 with respect to the axis A, in different angular positions, and each provided with at least one through hole.

The electric appliance 3, in both versions 3a and 3b, is provided with first and second known washing means 101 and 102 (FIG. 1), e.g. in the form of washing arms, which may be selectively connected, in use, to the first and second delivery pipes 6, 7, respectively, of the pump 1, and with constraint means 103 carried by the casing 10, to which the first 9 and second 12 fastening means of the pump 1 may be selectively connected to enable the selective arrangement of the pump 1 in a first (FIG. 3a) and second (FIG. 3b) working position with respect to the first and second washing means 101, 102, which positions are reciprocally inverted by simply inverting the pump 1 (e.g., rotating the pump by 180 degrees about axis A).

The pump body 4 further includes a closing lid 40 over the mouthpiece 22 of the scroll 20. The closing lid is essentially flange or plate-shaped, which is housed, in use, in a seat 29 defined internally by an annular collar 30 of the scroll 20, axially and cantileverly protruding with respect to the mouthpiece 22.

The lid 40 carries a suction pipe 41 in an axial position, which may be connected in use with the sump 11. The lid rests in use in axial abutment, with the interposition of a sealing ring 43 (o-ring), against an annular bottom wall 35 of the collar 30, which wall peripherally delimits the mouthpiece 22. The bottom wall 35 is preferably provided with an annular groove 36 (FIG. 4) for housing and radially and circumferentially containing the sealing ring 43 which, in non-deformed conditions (with the lid 40 not abutting against the wall 35), axially protrudes from the wall 35 towards the mouthpiece 22.

Finally, the pump body 4 includes a threaded locking ring 50 (threaded radially on the outside), that couples with a threaded segment 37 of the collar 30, internally to the same, to axially press in use the lid 40 against the annular bottom wall 35 of the collar 40, at the stroke end, uniformly along the whole peripheral edge 44 of the lid 40 itself, so as to ensure in use the application of a uniform pressure (by the edge 44) on the sealing ring 43.

The threaded locking ring 50 is substantially cup-shaped and is frontally provided, at a bottom annular wall 51 thereof, which is arranged perpendicularly to the threaded segment 37 internally to the collar and facing the lid 40 in use, with a through seat 53 for a safety fastening screw 54 intended to make the locking ring 50 and the lid 40 integral in use.

According to a first possible embodiment (not shown), the lid 40 is simply adapted to cooperate by friction with a stem 55 (FIG. 2) of the fastening screw 54 to avoid the accidental deviation of the locking ring 50 in use. According to another possible embodiment (the one shown), the lid 40 is provided in turn with a blind receiving seat 48 for the stem 55 of the fastening screw 54, which is arranged in use, when the locking ring 50 sandwiches the lid 40 against the annular bottom wall 35 of the collar 30, in an angular position corresponding to that of the through seat 53 of the locking ring 50, again to avoid the accidental deviation of the locking ring 50 itself in use.

The lid 40 and the scroll 20 may be provided with reciprocally mating relative positioning and angular locking means, respectively in the form of a tooth 49 of the lid 40 located on a side of the lid opposite the pipe 41 and very close to the edge 44, and of a slot 38 and a corresponding angular matching element 38b located on the scroll 20. The slot 38 is located at the mouthpiece 22 and the element 38B is located at a terminal end edge of the collar 30. The slot 38 is defined by the open end part of a radial ridge 39 located inside the scroll 20 and which extends axially from the bottom wall 23 to the mouthpiece 22, and being adapted to receive the tooth 49 in use.

Also the lid 40 and the locking ring 50 are formed by moulding a synthetic plastic resin and therefore the pump body 4 may be entirely formed by synthetic plastic material.

Both the first delivery pipe 6 and the second delivery pipe 7 are each laterally provided, perpendicularly to a side wall thereof, with a branched discharge conduit, indicated by numerals 70 and 71, preferably integrally obtained in one unitary piece with the pump body 4, in this case with the side wall of the collar 30, externally on the same. In use, in the case of the configuration in FIG. 3b, the discharge conduit 70 (FIG. 1) is closed by a plug 72 (FIG. 5), while the exhaust conduit 71 is in use connected to the sump 11, e.g. by means of a piping 77, diagrammatically indicated with a dashed-and-dotted line in FIG. 1.

In the configuration of FIG. 3a, instead, the conduit 70, which is in this case downwards, is connected to the sump 11, while the conduit 71 is closed by the plug 72.

In this manner, a minimum part of the water which is pumped through the pipe 6 or 7 which is arranged each time downwards, i.e. in a position below the axis A, is recirculated in the sump 11, with the advantage that when the pump 1 is stopped, the water which would normally remain trapped inside the scroll 20, may flow out through the piping 77 into the sump 11, thus greatly facilitating the maintenance operations of the pump 1.

1. A double delivery pump (1) for an electric appliance (3), the pump comprising a pump body (4) housing a centrifugal impeller (5) and provided with a first delivery pipe (6) and a second delivery pipe (7) located tangentially on the pump body in diametrically opposite positions with respect to a rotation axis (A) of the impeller, and with first fastening means (9) for pump mounting; characterised in that said first and second delivery pipes (6, 7) have flow passage sections that are different from one another; the pump also comprising, in combination, second fastening means (12) for pump mounting, the first and second fastening means (9, 12) being located and configured to be selectively used to mount the pump body, either with the first delivery pipe (6) arranged above and the second delivery pipe (7) arranged below the rotation axis (A) of the impeller or with the second delivery pipe (7) arranged above and the first delivery pipe (6) arranged below the rotation axis (A) of the impeller.

2. A pump (1) according to claim 1, characterised in that the pump body (4) comprises a hydraulic conveying scroll (20) defined by a cup-shaped half-shell comprising: a side wall (21) and a bottom wall (23), the side wall having a substantially cylindrical symmetry and delimiting a mouthpiece (22) of the scroll, through which the impeller is received in use into the scroll to be housed idley therein and, in use, to convey a service fluid of the electrical appliance through said scroll and towards the first and second delivery pipes (6, 7), the bottom wall arranged opposite to and facing the mouthpiece; said first and second delivery pipes (6, 7) being integral in one unitary piece with the side wall (21), and tangentially and cantileverly protruding from the side wall.

3. A pump (1) according to claim 2, characterised in that said impeller (5) is axially and cantileverly supported within said scroll by said bottom wall (23) of the scroll itself, through an axial passage hole (25) for a drive shaft (26); the bottom wall being provided, on the outside of the pump body, with fastening means (27) for a driving motor (28); said selectively usable first and second fastening means (9, 12) being carried outside the pump body by said side wall (21) of the scroll.

4. A pump (1) according to claim 2, characterised in that the pump body (4) further comprises a closing lid (40) of the mouthpiece, which is housed, in use, in a seat (29) defined by an annular collar (30) of the scroll, the annular collar axially and cantileverly protruding with respect to the mouthpiece, the lid carrying a suction pipe (41) in an axial position and resting in use in axial abutment, with the interposition of a sealing ring (43), against an annular bottom wall (35) of the collar, the annular bottom wall peripherally delimiting said mouthpiece (22).

5. A pump (1) according to claim 4, characterised in that the pump body (4) further comprises a externally threaded locking ring (50), that couples with a internally threaded segment (37) of the collar, to axially press the lid (40) against the annular bottom wall (35) of the collar, substantially uniformly along the whole peripheral edge (44) of the lid itself, so as to ensure in use a substantially uniform pressure on the sealing ring (43).

6. A pump (1) according to claim 5, characterised in that said locking ring (50) is substantially cup-shaped and is frontally provided, at a bottom wall (51) thereof which is arranged perpendicularly to said threaded segment (37) internally to the collar and facing the lid (40) in use, with a through seat (53) for a safety fastening screw (54) to make said locking ring (50) and said lid (40) integral in use.

7. A pump (1) according to claim 6, characterised in that said lid (40) is adapted to cooperate by friction with a stem (55) of said fastening screw to avoid accidental deviation of the locking ring (50) in use.

8. A pump (1) according to claim 6, characterised in that said lid (40) is provided with a blind receiving seat (48) for a stem (55) of said fastening screw, the receiving seat arranged in use, when said locking ring sandwiches said lid (40) against said annular bottom wall (35) of the collar, in an angular position corresponding to that of the through seat (53) of the locking ring, to avoid deviation of the locking ring.

9. A pump (1) according to claim 4, characterised in that said lid and said scroll are provided with mating relative positioning and angular locking means (38, 49).

10. A pump (1) according to claim 1, characterised in that said first and second selectively useable fastening means (9, 12) are formed by corresponding ears which are radially and cantileverly protruding from the pump body with respect to the axis (A) of the impeller, in different angular positions, and each provided with at least one through hole.

11. A pump (1) according to claim 1, characterised in that said pump body (4) is entirely formed by a synthetic plastic material.

12. A pump (1) according to claim 1, characterised in that each of said first and second delivery pipes (6, 7) is laterally provided, perpendicularly to a side wall thereof, with a branched discharge conduit (70, 71) integral with the pump body, externally on the same; a first of said discharge conduits (70, 71) being closed in use by a plug (75) and a second of the discharge conduits (70, 71) being connectable in use to a sump (11) of the electrical appliance, from which the pump is intended to draw a service fluid of the electric appliance.

13. A warewasher having an internal cavity, an upper washing arm, a lower washing arm, and a lower sump, a double delivery pump connected to pull water from the sump and deliver it to both the upper washing arm and the lower washing arm, the double delivery pump comprising:
a pump body, a centrifugal impeller within the pump body, a first delivery pipe located on the pump body, a second delivery pipe located on the pump body, the first delivery pipe and second delivery pipe in diametrically opposite positions with respect to a rotation axis (A) of the impeller, the first delivery pipe and second delivery pipe have flow passage cross-sectional areas that are different from one another.

14. The warewasher of claim 13 wherein the pump body comprises a hydraulic conveying scroll defined by a cup-shaped half-shell comprising: a side wall and a bottom wall, the side wall having a substantially cylindrical symmetry and delimiting a mouthpiece of the scroll, through which the impeller is received in use into the scroll to be housed idley therein and, the side wall directs a cleaning liquid of the warewasher towards the first and second delivery pipes, the bottom wall arranged opposite to and facing the mouthpiece; the first and second delivery pipes being integral in one unitary piece with the side wall, and tangentially and cantileverly protruding from the side wall.

15. The warewasher of claim 13 wherein each of the first and second delivery pipes includes a respective branched discharge conduit on an external lateral side thereof, a first of the discharge conduits being closed in use by a plug and a second of the discharge conduits being connected to the sump, the second of the discharge conduits being lower that the first of the discharge conduits.

16. A method of selectively manufacturing either a dishwasher or a glasswasher, the method comprising:
providing a double delivery pump having a pump body, a centrifugal impeller within the pump body, a first delivery pipe located on the pump body, a second delivery pipe located on the pump body, the first delivery pipe and second delivery pipe in diametrically opposite positions with respect to a rotation axis (A) of the impeller, a cross-sectional flow passage area of the first delivery pipe being smaller than a cross-sectional flow passage area of the second delivery pipe;
providing box-unit with having an internal cavity, an upper washing arm, a lower washing arm, and a lower sump;
identifying whether the box-unit is to be used as a dishwasher or a glasswasher;
if the box unit is identified for use as a glasswasher, mounting the pump to a casing of the box unit with the first delivery pipe connected to deliver cleaning liquid from the sump to the upper washing arm and with the second delivery pipe connected to deliver cleaning liquid from the sump to the lower washing arm, so that flow of cleaning liquid to the lower washing arm will be greater than flow of cleaning liquid to the upper washing arm; and
if the box unit is identified for use as a dishwasher, mounting the pump to the casing of the box unit with the second delivery pipe connected to deliver cleaning liquid from the sump to the upper washing arm and with the first delivery pipe connected to deliver cleaning liquid from the sump to the lower washing arm, so that flow of cleaning liquid to the upper washing arm will be greater than flow of cleaning liquid to the lower washing arm.

17. The method of claim 16 wherein
if the box unit is identified for use as a glasswasher, the pump is mounted with the first delivery pipe arranged higher than the second delivery pipe; and
if the box unit is identified for use as a dishwasher, the pump is mounted with the first delivery pipe arranged lower than the second delivery pipe.

18. The method of claim 17 wherein the double delivery pump includes a first fastening means and a second fastening means, and
if the box unit is identified for use as a glasswasher, the first fastening means is used to mount the pump to an attachment point of the casing, and the second fastening means is not used; and
if the box unit is identified for use as a dishwasher, the second fastening means is used to mount the pump to the attachment point of the casing, and the first fastening means is not used.
